(19) United States
(12) Patent Application Publication
(10) Pub. No.: US 2023/0233929 A1
(43) Pub. Date: Jul. 27, 2023

(54) CONTROLLER DEVICE WITH SEPARABLE PORTIONS

(71) Applicant: Apple Inc., Cupertino, CA (US)

(72) Inventors: Erin M. BOSCH, San Jose, CA (US); Stephen E. DEY, San Francisco, CA (US); Fletcher R. ROTHKOPF, Los Altos, CA (US); Sakoon JHAMB, Sunnyvale, CA (US)

(21) Appl. No.: 18/126,321

(22) Filed: Mar. 24, 2023

Related U.S. Application Data
(63) Continuation of application No. PCT/US21/47946, filed on Aug. 27, 2021.
(60) Provisional application No. 63/083,787, filed on Sep. 25, 2020.

(51) Int. Cl. A63F 13/24; H01R 13/62; G06F 3/01

(52) U.S. Cl. CPC A63F 13/24; H01R 13/6205; G06F 3/011

(57) ABSTRACT

Controller devices can provide a user with multiple modes of operation. For example, the user can hold and operate the controller device in a first configuration for control of a first device and/or first mode of a device (e.g. augmented reality or virtual reality programming), and the user can hold and operate controller segments of the controller device in a second configuration for control of a second device and/or second mode of a device (e.g. navigating an interface). The controller segments can be selectively engaged and disengaged to facilitate user operation in the different modes.

### CROSS-REFERENCE TO RELATED APPLICATION

This application is a continuation of International Application No. PCT/US21/47946, entitled “CONTROLLER DEVICE WITH SEPARABLE PORTIONS,” filed Aug. 27, 2021, which claims the benefit of U.S. Provisional Application No. 63/083,787, entitled “CONTROLLER DEVICE WITH SEPARABLE PORTIONS,” filed Sep. 25, 2020, the entirety of each of which is incorporated herein by reference.

### TECHNICAL FIELD

The present description relates generally to input devices, and, more particularly, to a controller device that provides multiple functions for a user to use in a variety of contexts.

### BACKGROUND

Controller devices are used to control various electronic devices such as televisions, media devices, and gaming devices. Typically, the controller device includes multiple buttons that can be pressed by a user to interact with the electronic device or to interact with a program or application displayed on the electronic device itself or on a second electronic device connected to the electronic device. The inputs provided by the user via the controller device can be communicated to the electronic device for execution of an action that corresponds to the input provided.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an elevation view of a controller device, in accordance with some embodiments of the present disclosure.

FIG. 2 illustrates an elevation view of the controller device of FIG. 1 with the controller segments separated, in accordance with some embodiments of the present disclosure.

FIG. 3 illustrates a perspective view of a controller device, in accordance with some embodiments of the present disclosure.

FIG. 4 illustrates a perspective view of the controller device of FIG. 3 with the controller segments joined, in accordance with some embodiments of the present disclosure.

FIG. 5 illustrates an elevation view of a controller device in an elongated configuration, in accordance with some embodiments of the present disclosure.

FIG. 6 illustrates an elevation view of the controller device of FIG. 4 in a folded configuration, in accordance with some embodiments of the present disclosure.

FIG. 7 illustrates a detail view of the controller device of FIG. 5, in accordance with some embodiments of the present disclosure.

FIG. 8 illustrates an engagement mechanism of a controller segment, in accordance with some embodiments of the present disclosure.

FIG. 9 illustrates an engagement mechanism of a controller segment, in accordance with some embodiments of the present disclosure.

FIG. 10 illustrates a block diagram of a controller device and an external device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Embodiments described herein provide a controller device that can be used with networked devices, such as computers, tablet computing devices, video streaming media player devices, head-mountable devices, virtual reality devices, augmented reality devices, and/or gaming devices. The controller device includes at least one controller segment. Each controller segment can include an interface portion for a user to operate and provide inputs. The inputs can include buttons, joysticks, and/or touch input. In some applications, the controller segments can also detect positioning or motion of the user's hands for navigating augmented reality or virtual reality programming. For other uses, the controller segments can be attached together for other uses, such as navigating interfaces or gaming activities. The controller segment can releasably engage with a mating controller segment via an engagement mechanism. The controller segments can engage with each other directly without any intermediate devices. When the controller segments are attached, the controller device can provide additional inputs and/or provide a familiar user experience.

Controller devices described herein can provide a user with multiple modes of operation. For example, the user can hold and operate the controller device in a first configuration for control of a first device and/or first mode of a device (e.g. augmented reality or virtual reality programming), and the user can hold and operate controller segments of the controller device in a second configuration for control of a second device and/or second mode of a device (e.g. navigating an interface). The controller segments can be selectively engaged and disengaged to facilitate user operation in the different modes.

These and other embodiments are discussed below with reference to FIGS. 1-10. However, those skilled in the art will readily appreciate that the detailed description given herein with respect to these Figures is for explanatory purposes only and should not be construed as limiting.

Referring now to FIG. 1, the controller device 100 can be used to control the operation of an external device, including, but not limited to, computers, tablet computing devices, video streaming media player devices, head-mountable devices, virtual reality devices, augmented reality devices, and/or gaming devices. In the depicted example, the controller device 100 can allow for control of the operation of the external device in a first mode or configuration, wherein the user can control the external device at least partially through the independent motion of each of the user's hands and/or arms by independently using a first controller segment 110a and a second controller segment 110b. As described herein, each controller segment 110a, 110b is an input device that can provide signals to an external device to control operation of the external device. While the controller segments 110a, 110b can be moved independently, the controller segments 110a, 110b can cooperatively provide signals to the external device to control operation of the external device.

Further, the controller device 100 can allow for the operation of the external device in a second mode or configuration, wherein the user can control the external device with each of the user's hands at generally the same or common position by cooperatively using the first controller segment 110a and the second controller segment 110b positioned or joined together. In the depicted example, the first controller segment 110a and the second controller segment 110b are releasably attached to each other to allow the controller device 100 to be used in an independent or joined configuration. Further, the first controller segment 110a and the second controller segment 110b can each be moved between a first position and a second position to adjust the ergonomics and functionality of the first controller segment 110a and the second controller segment 110b.

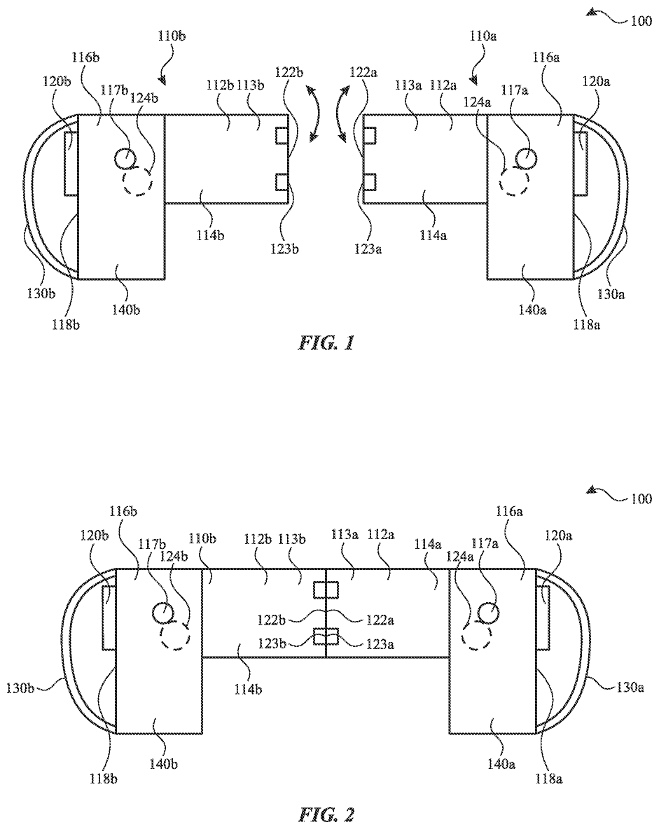

With reference to FIGS. 1 and 2, the first controller segment 110a includes a segment body 112a configured to be held by the user. The segment body 112a can have a generally rectangular shape or profile. In some embodiments, the segment body 112a can be formed in other shapes, such as an ellipsoidal shape. The segment body 112a defines an interior cavity (not shown) disposed between the face 114a, lower surfaces, and the sidewalls 118a of the segment body 112a. The segment body 112a can be made of any suitable material or materials, such as a metal, a plastic, glass, and/or combinations thereof.

The interior cavity can include various structural, electrical and/or mechanical components. For example, the interior cavity can include a power source such as one or more batteries or rechargeable batteries and a main logic board. The main logic board can include various integrated circuits in addition to one or more processing devices. One or more wireless communication devices such as an infrared, Bluetooth®, WiFi, or RF device can be included in the interior cavity.

Optionally, the controller segments 110a can include extensions or handle portions to provide for user comfort. As illustrated, the first controller segment 110a includes a handle portion 140a extending away from the segment body 112a. The handle portion 140a can be rigidly coupled to the segment body 112a. In some embodiments, the handle portion 140a is integrally formed with the segment body 112a. Optionally, the handle portion 140a is a separate component that is coupled to the segment body 112a. The handle portion 140a can be rotatable or movable relative to the segment body 112a.

In some embodiments, the controller segment 110a can be generally shaped or otherwise configured to allow the user to grasp the handle portion 140a between the user's finger's and palm, leaving the user's thumb to interact with the controls described herein.

In the depicted example, the segment body 112a includes a movable portion 113a that is rotatable, slidable, pivotable, or otherwise movable relative to the handle portion 140a. The movable portion 113a can be coupled to the handle portion 140a via a joint 124a. The joint 124a can allow for rotation, sliding, pivoting, articulation, or other movement of the movable portion 113a relative to the handle 140a and/or the segment body 112a. During operation, the movable portion 113a can be moved between a first position and a second position.

In a first position the movable portion 113a can be extended away from the handle portion 140a, such that the movable portion 113a is vertically or longitudinally aligned with the handle portion 140a. In a second position, the movable portion 113a can be disposed at an obtuse angle relative to the handle portion 140a, forming a “pistol” shape.

In certain embodiments, the movable portion 113a is positionable between the first position and the second position. Optionally, the position or angle of the movable portion 113a relative to the handle portion 140a can be adjusted to provide a desired angle between the handle portion 140a and the movable portion 113a.

The first controller segment 110a can include a locking mechanism to retain the movable portion 113a in a desired position, such as the first position, the second position, or a position in between the first position and the second position. Upon release of the locking mechanism, the movable portion 113a may be moved to a desired angle, position or configuration. In some embodiments, the locking mechanism is a mechanical locking mechanism. For example, the locking mechanism can mechanically engage with the joint 124a, locking the rotational position of the movable portion 113a relative to the handle portion 140a. The locking mechanism may be released by depressing or otherwise engaging the joint 124a. Optionally, the locking mechanism can be an electromechanical locking mechanism. An electromechanical locking mechanism may lock and release the rotational position of the movable portion 113a relative to the handle portion 140a in response to a button press, a command from an external device, or bringing the first controller segment 110a in proximity with the second controller segment 110b.

Optionally, the first controller segment 110a can include a biasing member to urge the movable portion 113a toward an first position or toward a second position. The biasing member, such as a spring, can be energized by rotating the movable portion 113a in a direction opposite to the urging direction. For example, the biasing member can urge the movable portion 113a toward a deployed or first position. Accordingly, the biasing member can be energized by forcing the movable portion 113a into second position. The biasing member can be released by the locking mechanism described herein.

In the depicted example, the first controller segment 110a can include an interface portion 116a to receive inputs from the user. The interface portion 116a can include one or more sensors, such as buttons, capacitive sensors, pressure sensors, etc. to receive touch inputs from the user. In some embodiments, the interface portion 116a can distinguish between various inputs according to where the user touches the interface portion 116a or the pressure applied by the user. In some embodiments, the movable portion 113a can include additional inputs for the user.

In some embodiments, the interface portion 116a can be a touch sensitive portion of the segment body 112a. The interface portion 116a can be defined on the outer surface of the segment body 112a. Optionally, the interface portion 116a can be defined as a concave portion or convex portion along the outer surface of the segment body 112a. The interface portion 116a can be defined as a generally circular portion, generally elongated, or elliptical portion along the segment body 112a. The interface portion 116a can be defined on the front face 114a of the segment body 112a. In some embodiments, the interface portion 116a can be positioned to receive inputs from the user's appendage or digit (e.g. thumb) when held by the user.

As illustrated, the interface portion 116a can include one or more buttons 117a. As can be appreciated, the buttons 117a can be positioned and/or shaped in a suitable configuration to receive inputs from the user's appendages and/or digits when held by the user.

The buttons 117a can provide for a variety of user inputs to control the external device. The buttons 117a can be formed with any suitable material, including metal or plastic. The buttons 117a can be flush with the surface of the segment body 112a, be recessed with respect to the surface of the segment body 112a, protrude or extend beyond the surface of the segment body 112a, and/or a combination of these configurations. For example, in some embodiments, some of the buttons 117a are flush while other buttons 117a protrude. Additionally or alternatively, the buttons 117a can have any given shape and/or surface. For example, a button 117a can have a textured, concave, and/or convex surface while another button 117a has a smooth or flat surface. The buttons 117a can be shaped differently to assist a user in identifying the buttons 117a from one another. Raised symbols can be formed in surfaces thereof and/or an area around the buttons 117a. The buttons 117a and/or an area around the buttons 117a can be illuminated to aid a user in identifying a button 117a and its function.

The first controller segment 110a can include additional inputs, such as a trigger button 120a disposed along the sidewall 118a of the segment body 112a. The trigger button 120a can provide an additional or alternative input to the inputs provided by the interface portion 116a. The trigger button 120a can be positioned to receive inputs from another digit (e.g. index finger) when held by the user.

Optionally, the controller segment 110a can each include a retention mechanism to secure the controller segment 110a to the user's hands. In some embodiments, the retention mechanism includes strap 130a coupled to the controller segment 110a. For example, the ends of the strap 130a can be coupled to the segment body 112a or handle portion 140a permitting a user's hand to be disposed between the strap 130a and segment body 112a, securing the controller segment 110a to the user's hand. Optionally, the strap 130a can include a loop to allow the user's hand to pass therethrough. The length of the strap 130a can be adjusted to fit various users. The strap 130a can be formed from various materials including, but not limited to fabric, plastic, elastomers, etc.

Optionally, the strap 130a can be retracted when not in use. The strap 130a can be retracted into or deployed from the segment body 112a. In some embodiments, an end of the strap 130a can be detached upon retraction of the strap 130a. In other embodiments, the strap 130a can be retracted to be taut against the segment body 112a, reducing the space between the strap 130a and the segment body 112a.

In some embodiments, the retention mechanism can include a rigid retention member. The rigid retention member can be a deployable member to secure controller segment 110a to the user's hand. The rigid retention members can engage with a user's fingers, etc. The rigid retention member can be stowed or retracted when not in use.

In some applications, a retention mechanism can be utilized when the controller device 100 is in an independent configuration to allow the controller segment 110a to remain secured to the user's hands as the user moves their hands and/or arms. As can be appreciated, a retention mechanism can also be used to secure the controller device 100 in a tandem or joined configuration.

In some embodiments, the second controller segment 110b can have a similar construction or arrangement as the first controller segment 110a. Therefore, the second controller segment 110b can include the same or similar elements as first controller segment 110a. As illustrated in FIG. 1, similar elements of the first controller segment 110a can be referred to with similar reference numerals with respect to second controller segment 110b. For example, the segment body 112b of the second controller segment 110b can be referred to with a similar reference numeral as the segment body 112a of the first controller segment 110a.

Optionally, the first controller segment 110a and the second controller segment 110b can be configured to be held in a user's right and left hands, respectively. Accordingly, in some embodiments, the first controller segment 110a and the second controller segment 110b can be symmetrically arranged relative to each other. For example, the shape, positioning, and/or arrangement of the interface portion 116a of the first controller segment 110a, including the shape, positioning and/or arrangement of the buttons 117a can be a mirror image or bilaterally symmetrical to the shape, positioning, and/or arrangement of the interface portion 116b of the second controller segment 110b, including the shape, positioning and/or arrangement of the buttons 117b, when the controller segments 110a, 110b are coupled. In other words, the arrangement of the interface portion 116a relative to the engagement face 122a can be a mirror image or bilaterally symmetrical to the arrangement of the interface portion 116b relative to the engagement face 122b. Accordingly, when the controller segments 110a, 110b are coupled, the arrangement of the interface portion 116a can be symmetrical to the arrangement of the interface portion 116b about the plane of engagement or coupling of the controller segments 110a, 110b. Advantageously, by providing a symmetrical layout of controller segments 110a, 110b, users may be able to learn operation of the controller device 100 more quickly, the design of the controller device 100 may be more visually appealing, and manufacturing of the controller device 100 can be simplified.

In some embodiments, the first controller segment 110a and the second controller segment 110b can be asymmetrically arranged. For example, the controller segments 110a, 110b can each be in the first position, the second position, or a position in between the first position and the second position. Further, the first controller segment 110a and the second controller segment 110b can have different components, arrangements, and/or features. As can be appreciated, while the controller segments 110a, 110b may have different configurations, the controller segments 110a,110b may mate, interface, or otherwise be used together to control an external device.

As illustrated in FIG. 1, each controller segment 110a, 110b, can be used in an independent configuration wherein the user can control the external device at least partially through the independent motion of each of the user's hands and/or arms. For example, during operation, a user can grasp the first controller segment 110a in a right hand and the second controller segment 110b in a left hand, and independently move the user's right and left hands to control the external device.

In certain applications, each controller segment 110a, 110b can be utilized to track the motion of the user's appendages (e.g. hand and/or arm) to provide position, velocity, and/or acceleration information to an external device, such as an augmented reality device and/or a virtual reality device. As described herein, each controller segment 110a, 110b can utilize an inertial measurement unit (IMU) to provide information regarding each controller segment's position, velocity, and/or acceleration based on six degrees of freedom (x, y, z, θₓ, θ_{y}, and θ_{z}).

As illustrated, the segment body 112a, 112b of each controller segment 110a, 110b can have a form factor or shape configured to be held in a user's hand independent of the other controller segment. As can be appreciated, each controller segment 110a, 110b can be used independently while in either the first position or the second position. For example, in the first position or “aligned” position, the controller segments 110a, 110b can have a form factor that allows the user to grasp the handle portion 140a, 140b between the user's fingers and palm, leaving the user's thumb to interact with the interface portion 116a, 116b and other controls described herein. Further, in the second position or “pistol” position, the controller segments 110a, 110b can have a form factor that allows the user to grasp the handle portion 140a, 140b between the user's fingers and palm while the movable portion 113a, 113b extends away from the handle portion 140a, 140b, leaving the user's thumb to interact with the interface portion 116a, 116b and other control described herein. Optionally, the controller segments 110a, 110b can be configured to attach to other program-specific devices or accessories (e. g. a tennis racket for a sports game).

Alternatively, the controller segments 110a, 110b can be mating controller segments 110a, 110b that are mated or joined together and used in tandem in a joined or combined configuration, wherein the user can control the external device through inputs provided by the user's digits with both of the user's hands at generally common position. As can be appreciated, a controller segment 110a configured to control an external device can be joined with a mating controller segment 110b that is also configured to control the external device. For example, during operation, the controller segments 110a, 110b can be joined together as a unified controller device 100, wherein the user can grasp the right portion of the controller device 100 formed by the right controller segment 110a in the right hand and the left portion of the controller device 100 formed by the left controller segment 110b in the left hand.

With reference to FIG. 2, when the controller segments 110a, 110b are joined together, the controller device 100 can have a form factor or shape configured to be held between both of the user's hands. As can be appreciated, the joined controller segments 110a, 110b can be used while in either the first or second position. In some embodiments, one of the joined controller segments 110a, 110b can be in a first position wherein the movable portion 113a, 113b extends away from the handle portion 140a, 140b in a vertical or longitudinal alignment, and the other joined controller segment 110a, 110b is in a second position wherein the movable portion 113a, 113b is in a second position wherein the movable portion 113a, 113b is disposed at an obtuse angle relative to the handle portion 140a, 140b, forming a “pistol” shape. As can be appreciated, while the user may interact with the external device primarily via the interface portions 116a, 116b, and/or the trigger buttons 120a, 120b, the controller device 100 can further utilize provide position, velocity, and/or acceleration information in a joined configuration.

In addition to controlling the external device, the controller segments 110a, 110b can be joined together for storage and/or charging of the controller device 100.

In the depicted example, the first controller segment 110a and the second controller segment 110b are releasably attached to each other to allow the controller device 100 to be used in an independent or joined configuration. During operation, an engagement mechanism 123a of the first controller segment 110a can engage with an engagement mechanism 123b of the second controller segment 110b to releasably attach the first controller segment 110a to the second controller segment 110b. In some embodiments, the moveable portion 113a of the first controller segment 110a can releasably engage with a mating movable portion 113b of the second controller segment 110b.

In the depicted example, the engagement mechanism 123a engages the engagement face 122a of the segment body 112a with the engagement face 122b of the segment body 112b, providing contact between the engagement faces 122a, 122b and therefore the controller segments 110a, 110b. In some embodiments, the engagement mechanism 123a, 123b can provide releasable attachment of the controller segments 110a, 110b by engaging or attaching to other portions of the bodies 112a, 112b. Optionally, the engagement faces 122a, 122b are disposed or formed on the respective movable portions 113a, 113b.

In some embodiments, the engagement faces 122a, 122b are planar surfaces that allow contact and/or engagement between the first controller segment 110a and the second controller segment 110b. Optionally, when the first controller segment 110a and the second controller segment 110b are coupled or otherwise engaged to each other, the engagement faces 122a, 122b of the controller segments 110a, 110b can be in direct contact with each other with no intermediate connection portions or pieces. In some embodiments, the first controller segment 110a and the second controller segment 110b can be connected together with an intermediate connection portion, spacing apart the engagement faces 122a, 122b.

In some embodiments, the engagement mechanisms 123a, 123b can utilize a magnetic engagement mechanism. The engagement mechanisms 123a,123b can include magnetic elements disposed within or on the respective bodies 112a, 112b that allow the engagement mechanisms 123a,123b to attract to each other when in close proximity. The engagement mechanisms 123a,123b can be disposed on, embedded in, or adjacent to the engagement faces 122a, 122b. Therefore, when in close proximity, the engagement mechanisms 123a,123b can cause the engagement faces 122a, 122b to come in contact and become attached. Further, the engagement mechanisms 123a,123b can be disengaged by pulling the first controller segment 110a and the second controller segment 110b apart. Optionally, the magnetic elements of the engagement mechanisms 123a,123b can be electromagnets that are controlled by an internal controller, software, or another mechanism to control the attachment and release of the first controller segment 110a and the second controller segment 110b. In some embodiments, the magnetic elements of the engagement mechanism 123a, 123b can be controlled or otherwise actuated by the movement of the movable portions 113a, 113b.

In some embodiments, the engagement mechanisms 123a,123b can utilize a mechanical engagement mechanism. The engagement mechanisms 123a,123b can include interlocking elements disposed on the respective bodies 112a, 112b that allow the engagement mechanisms 123a,123b to interlock when attached. The engagement mechanisms 123a,123b can be disposed on or around the engagement faces 122a, 122b. For example, the engagement mechanism 123a can include a hook element and the engagement mechanism 123b can include an undercut element that allows the hook of engagement mechanism 123a to attach to the undercut element of the engagement mechanism 123b. Therefore, when pressed together the engagement mechanisms 123a,123b can attach and retain engagement faces 122a, 122b in contact. Further, the engagement mechanisms 123a,123b can be disengaged by pulling the first controller segment 110a and the second controller segment 110b apart. In some embodiments, the engagement mechanisms 123a,123b are formed from resilient materials to allow for the engagement mechanisms 123a,123b to attach and detach. Optionally, the elements of the engagement mechanisms 123a,123b can be actuated to be controlled by an internal controller, software, or another mechanism to control the attachment and release of the first controller segment 110a and the second controller segment 110b. In some embodiments, the elements of the engagement mechanism 123a, 123b can be controlled or otherwise actuated by the movement of the movable portions 113a, 113b.

Optionally, the engagement mechanisms 123a,123b can provide electrical connections between the first controller segment 110a and the second controller segment 110b when engaged. The engagement mechanisms 123a,123b can utilize the features that allow for a mechanical coupling to provide electrical connections between the first controller segment 110a and the second controller segment 110b. In some embodiments, the engagement mechanisms 123a,123b can utilize additional pins or connectors to provide electrical connections between the first controller segment 110a and the second controller segment 110b. Advantageously, by providing electrical connections between the controller segments 110a, 110b, the controller device 100 can share signals, sensors, outputs, power sources, etc. between the controller segments 110a, 110b. In some embodiments, the electrical connections of the engagement mechanisms 123a,123b can facilitate charging of the controller device 100 through a single connection.

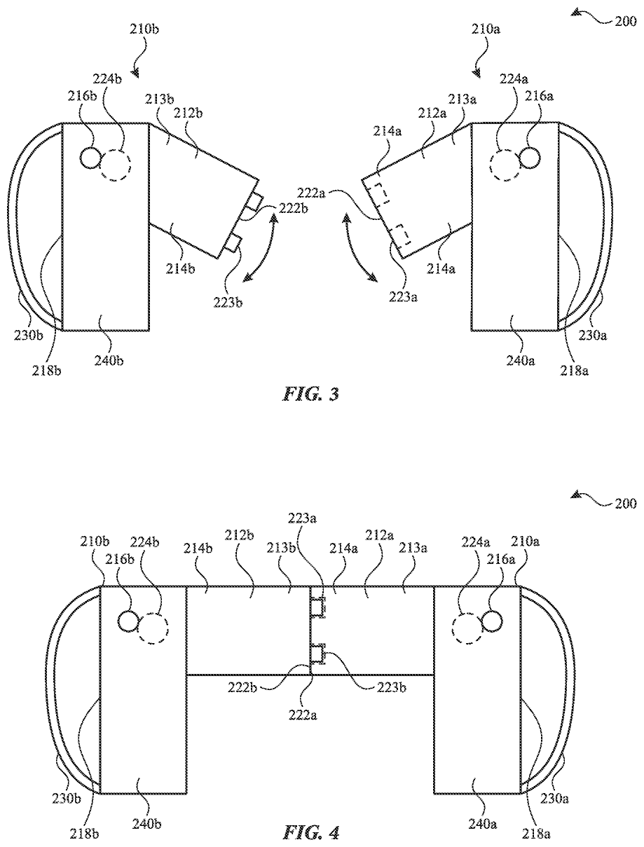

With reference to FIGS. 3 and 4, similar to controller device 100, the controller device 200 includes a first controller segment 210a a the second controller segment 210b that can be releasably attached to each other to be used in an independent or joined configuration. Additionally, the first controller segment 210a and the second controller segment 210b can each be moved between a compact configuration and an expanded configuration to adjust the ergonomics and functionality of the first controller segment 210a and the second controller segment 210b.

The first controller segment 210a includes a segment body 212a with bridge portion 213a and a handle portion 240a. In the depicted example, the bridge portion 213a and the handle portion 240a can be coupled about a hinge or pivot 224a, allowing the bridge portion 213a to rotate relative to the handle portion 240a. During operation, the bridge portion 213a can be rotated between a compact configuration and an expanded configuration.

In an expanded configuration, the bridge portion 213a can be extended away from the handle portion 240a, such that the handle portion 240a is disposed at an obtuse angle relative to the bridge portion 213a. In the compact configuration, the bridge portion 213a can be rotated toward the handle portion 240a, minimizing the space between the bridge portion 213a and the handle portion 240a. In some embodiments, the bridge portion 213a can be disposed or stowed inside a recessed portion or cavity defined in the handle portion 240a in a compact configuration. Optionally, the bridge portion 213a can be fully enclosed within the handle portion 240a in a compact configuration.

In certain embodiments, the bridge portion 213a is positionable between a fully expanded configuration and a fully compact configuration. Optionally, the position or angle of the bridge portion 213a relative to the handle portion 240a can be adjusted to provide a desired angle between the handle portion 240a and the bridge portion 213a.

The first controller segment 210a can include a locking mechanism to retain the bridge portion 213a in a desired position, such as the expanded configuration, the compact configuration, or a position in between a fully expanded state and a fully compact state. Upon release of the locking mechanism, the bridge portion 213a may be moved to a desired angle, position or configuration. In some embodiments, the locking mechanism is a mechanical locking mechanism. For example, the locking mechanism can mechanically engage with the pivot 224a, locking the rotational position of the bridge portion 213a relative to the handle portion 240a. The locking mechanism may be released by depressing or otherwise engaging the pivot 224a. Optionally, the locking mechanism can be an electromechanical locking mechanism. An electromechanical locking mechanism may lock and release the rotational position of the bridge portion 213a relative to the handle portion 240a in response to a button press, a command from an external device, or bringing the first controller segment 210a in proximity with the second controller segment 210b.

Optionally, the first controller segment 210a can include a biasing member to urge the bridge portion 213a toward an expanded configuration or toward a compact configuration. The biasing member, such as a spring, can be energized by rotating the bridge portion 213a in a direction opposite to the urging direction. For example, the biasing member can urge the bridge portion 213a toward a deployed or expanded configuration. Accordingly, the biasing member can be energized by forcing the bridge portion 213a into the compact configuration. The biasing member can be released by the locking mechanism described herein.

In the depicted example, the first controller segment 210a can include an interface portion 216a to receive inputs from the user. The interface portion 216a can include one or more sensors, such as buttons, capacitive sensors, pressure sensors, etc. to receive touch inputs from the user. In some embodiments, the interface portion 216a can be a touch sensitive portion of the handle portion 240a. In some embodiments, the bridge portion 213a can include additional inputs for the user.

In some embodiments, the controller segment 210a can include a retention mechanism to secure the controller segment 210a to the user's hand. In some embodiments, the retention mechanism includes a strap 230a coupled to the controller segment 210a. For example, a first end of the strap 230a can be coupled to an upper portion of the handle portion 240a, and a second end of the strap 230a can be coupled to a lower portion of the handle portion 240a, permitting a user's hand to be disposed between the strap 230a and the handle portion 240a, securing the controller segment 210a to the user's hand. The length of the strap 230a can be adjusted to various users.

As can be appreciated, the second controller segment 210b can have a similar construction or arrangement as the first controller segment 210a. Therefore, the second controller segment 210b can include the same or similar elements as first controller segment 210a. Accordingly, similar elements of the first controller segment 210a can be referred to with similar reference numerals with respect to second controller segment 210b.

Optionally, the first controller segment 210a and the second controller segment 210b can be configured to be held in a user's right and left hands, respectively. Accordingly, in some embodiments, the first controller segment 210a and the second controller segment 210b can be symmetrically arranged relative to each other. In some embodiments, the first controller segment 210a and the second controller segment 210b can be asymmetrically arranged. As can be appreciated, the controller segments 210a, 210b can each be in an expanded or compact configuration. Further, the first controller segment 210a and the second controller segment 210b can have different components, arrangements, and/or features.

With reference to FIG. 3, each controller segment 210a, 210b, can be used in an independent configuration wherein the user can control the external device at least partially through the independent motion of each of the user's hands and/or arms. As can be appreciated, each controller segment 210a, 210b can be used independently while in either a compact or expanded configuration. For example, in a compact configuration, the controller segments 210a, 210b can have a form factor that allows the user to grasp the handle portion 240a, 240b between the user's fingers and palm, leaving the user's thumb to interact with the interface portion 216a, 216b and other controls described herein. Further, in an expanded configuration, the controller segments 210a, 210b can have a form factor that allows the user to grasp the handle portion 240a, 240b between the user's fingers and palm while the bridge portion 213a, 213b extends away from the handle portion 240a, 240b, leaving the user's thumb to interact with the interface portion 216a, 216b and other control described herein.

With reference to FIG. 4, the controller segments 210a, 210b can be joined together and used in tandem in a joined or combined configuration, wherein the user can control the external device through inputs provided by the user's digits with both of the user's hands at generally common position. For example, during operation, the controller segments 210a, 210b can be joined together as a unified controller device 200. The controller segments 210a, 210b can be joined together with each controller segment 210a, 210b in an expanded configuration. Therefore, the bridge portion 213a of the first controller segment 210a can be joined together with the bridge portion 213b of the second controller segment 210b, allowing the user to grasp the handle portion 240a of the right controller segment 210a in the right hand and the handle portion 240b of the left controller segment 210b in the left hand.

When the controller segments 210a, 210b are joined together, the controller device can have a form factor or shape configured to be held between both of the user's hands. For example, the handle portions 240a, 240b can extend away from the joined bridge portions 213a, 213b at an obtuse angle to allow the user's hands and/or arms to be positioned in a comfortable manner when the controller segments 210a, 210b are joined together.

In the depicted example, the first controller segment 210a and the second controller segment 210b are releasably attached to each other to allow the controller device to be used in an independent or joined configuration. In some embodiments, the bridge portion 213a of the first controller segment 210a can releasably engage with a mating bridge portion 213b of the second controller segment 210b.

Optionally, the bridge portion 213a of the first controller segment 210a can releasably engage with another portion of the controller segment 210b, such as the handle portion 240b. In some applications, the bridge portion 213a can have an extended length to space apart the controller segments 210a, 210b when connected. The length of the bridge portion 213a can be adjusted to extend the length that the bridge portion 213a extends from the handle portion 240a in an expanded configuration. In some applications, the bridge portion 213a can be pulled, twisted, or otherwise urged to extend the bridge portion 213a relative to the handle portion 240a. The first controller segment 210a can include detents or stops to allow the bridge portion 213a to extend to various predetermined lengths. By adjusting the length of the bridge portion 213a, the distance between the handle portions 240a, 240b in the joined configuration can be adjusted to suit various users.

During operation, an engagement mechanism 223a of the first controller segment 210a can engage with an engagement mechanism 223b of the second controller segment 210b to releasably attach the first controller segment 210a to the second controller segment 210b. In the depicted example, the engagement mechanism 223a is disposed on or within an engagement face 222a of the bridge portion 213a and the engagement mechanism 223b is disposed on or within an engagement face 222b of the bridge portion 213b, providing contact between the engagement faces 222a, 222b during engagement. In some embodiments, the engagement mechanism 223a, 223b can provide releasable attachment of the controller segments 210a, 210b by engaging or attaching to other portions of the bodies 212a, 212b.

In some embodiments, the engagement faces 222a, 222b are planar surfaces that allow contact and/or engagement between the first controller segment 210a and the second controller segment 210b. Optionally, when the first controller segment 210a and the second controller segment 210b are coupled or otherwise engaged to each other, the engagement faces 222a, 222b of the bridge portions 213a, 213b can be in direct contact with each other with no intermediate connection portions or pieces. In some embodiments, the first controller segment 210a and the second controller segment 210b can be connected together with an intermediate connection portion, spacing apart the engagement faces 222a, 222b.

In the depicted example, the engagement mechanism 223a, 223b can include interlocking or mating pins and ports. In some embodiments, the engagement mechanism 223b can include one or more pins extending from the engagement face 222b. The engagement mechanism 223a can include corresponding ports or holes disposed within the engagement face 222a. The mating holes of the engagement mechanism 223a can be configured to receive the pins from the engagement mechanism 223b. The pins of the engagement mechanism 223b can frictionally engage with the mating holes of the engagement mechanism 223a. In some embodiments, the pins of the engagement mechanism 223b include keyed features or expanding features that engage with the mating holes of the engagement mechanism 223a.

Optionally, the engagement mechanism 223a, 223b can be moved or otherwise actuated by movement or rotation of the bridge portions 213a, 213b. In some embodiments, the pins of the engagement mechanism 223b can move as the bridge portion 213b is rotated. For example, the pins of the engagement mechanism 223b can extend outward away from the engagement face 222b to allow for mating, as the bridge portion 213b is moved toward an expanded configuration. Further, the pins of the engagement mechanism 223b can retract inward into the engagement face 222b to allow for the bridge portion 213b to be stowed, as the bridge portion 213b is moved toward the compact configuration. The pins of the engagement mechanism 223b can be obscured or otherwise covered by the handle portion 240b when the bridge portion 213b is positioned or disposed within the cavity of the handle portion 240b.

Further, the ports of the engagement mechanism 223a can move as the bridge portion 213a is rotated. For example, the ports of the engagement mechanism 223a can contract to allow for engagement with the pins of the engagement mechanism 223b, as the bridge portion 213a is moved toward an expanded configuration. Further, the ports of the engagement mechanism 223a can expand to allow pins of the engagement mechanism 223b to be released, as the bridge portion 213a is moved toward the compact configuration. The ports of the engagement mechanism 223a can be obscured or otherwise covered by the handle portion 240a when the bridge portion 213a is positioned or disposed within the cavity of the handle portion 240a.

Optionally, similar to controller device 100, the engagement mechanisms 223a,223b can provide electrical connections between the first controller segment 210a and the second controller segment 210b when engaged. In some embodiments, the pins of the engagement mechanism 223b and the ports of the engagement mechanism 223a can provide one or more electrical contacts to transfer energy, signals, etc.

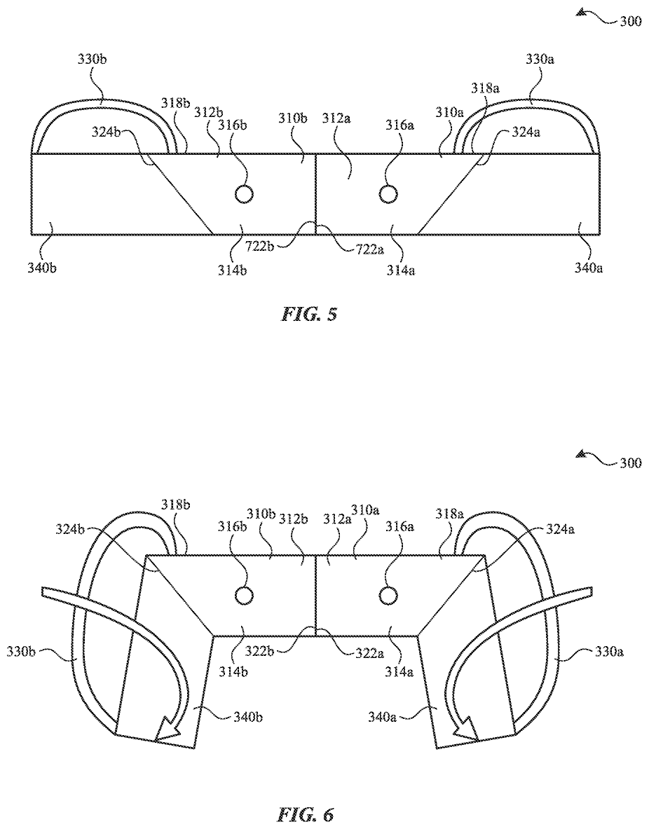

With reference to FIGS. 5 and 6, similar to controller device 100, the controller device 300 includes a first controller segment 310a and the second controller segment 310b can be releasably attached to each other to be used in an independent or joined configuration. Additionally, the first controller segment 310a and the second controller segment 310b can each be moved or rotated between a linear configuration and rotated configuration to adjust the ergonomics and functionality of the first controller segment 310a and the second controller segment 310b.

The first controller segment 310a includes a segment body 312a with a handle portion 340a. In the depicted example, the segment body 312a and the handle portion 340a can be coupled about a rotational joint 324a, allowing the handle portion 340a to rotate relative to the segment body 312a. During operation, the handle portion 340a can be rotated between a linear configuration and a rotated configuration. In some embodiments, the rotation of the handle portion 340a can actuate portions of the segment body 312a. For example, rotation of the handle portion 340a can vary the size or diameter of the segment body 312a to adjust for various users.

With reference to FIG. 5, in a linear configuration the handle portion 340a is axially aligned with a longitudinal axis with the segment body 312a, such that the handle portion 340a and the segment body 312a form a generally linear arrangement. With reference to FIG. 6, in a rotated configuration, the handle portion 340a can be rotated to be angled away from the segment body 312a, such that the handle portion 340a is disposed at an obtuse angle relative to the segment body 312a. As illustrated, the handle portion 340a can rotate or swivel about a diagonal plane relative to the segment body 312a to allow the handle portion 340a to move along multiple axes, relative to the segment body 312a from a linear configuration to a rotated configuration. In some embodiments, an end portion or face of the segment body 312a defines the diagonal plane which the handle portion 340a rotates about. For example, to move from the linear configuration to the rotated configuration, the handle portion 340a can be rotated simultaneously upward and inward along the diagonal plane defined by the segment body 312a. Near the center of the travel of the handle portion 340a, the handle portion 340a can be rotated simultaneously downward and inward along the same diagonal plane to move the handle portion 340a into the rotated configuration. As can be appreciated, the motion of the handle portion 340a can be reversed to move the handle portion 340a to the linear configuration.

In certain embodiments, the handle portion 340a is positionable between a fully linear configuration and a fully rotated configuration. Optionally, the position or angle of the handle portion 340a relative to the segment body 312a can be adjusted to provide a desired angle between the handle portion 340a and the segment body 312a.

The first controller segment 310a can include a locking mechanism to retain the handle portion 340a in a desired position, such as the rotated configuration, the linear configuration, or a position in between a fully rotated state and a fully linear state. Upon release of the locking mechanism, the handle portion 340a may be moved to a desired angle, position or configuration. In some embodiments, the locking mechanism is a mechanical locking mechanism. For example, the locking mechanism can mechanically engage with the rotational joint 324a, locking the rotational position of the handle portion 340a relative to the segment body 312a. The locking mechanism may be released by depressing or otherwise engaging the rotational joint 324a. Optionally, the locking mechanism can be an electromechanical locking mechanism. An electromechanical locking mechanism may lock and release the rotational position of the handle portion 340a relative to the segment body 312a in response to a button press, a command from an external device, or bringing the first controller segment 310a in proximity with the second controller segment 310b.

In the depicted example, the first controller segment 310a can include an interface portion 316a to receive inputs from the user. The interface portion 316a can include one or more sensors, such as buttons, capacitive sensors, pressure sensors, etc. to receive touch inputs from the user. In some embodiments, the interface portion 316a can be a touch sensitive portion of the handle portion 340a.

In some embodiments, the controller segment 310a can include a retention mechanism to secure the controller segment 310a to the user's hand. In some embodiments, the retention mechanism includes a strap 330a coupled to the controller segment 310a. For example, a first end of the strap 330a can be coupled to the segment body 312a, and a second end of the strap 330a can be coupled to the handle portion 340a, permitting a user's hand to be disposed between the strap 330a and the handle portion 340a, securing the controller segment 310a to the user's hand. The length of the strap 330a can be adjusted to various users. As can be appreciated, the strap 330a can secure the controller segment 310a in either the linear configuration or the rotated configuration.

The second controller segment 310b can have a similar construction or arrangement as the first controller segment 310a. Therefore, the second controller segment 310b can include the same or similar elements as first controller segment 310a. As illustrated in FIGS. 5 and 6, similar elements of the first controller segment 310a can be referred to with similar reference numerals with respect to second controller segment 310b.

Optionally, the first controller segment 310a and the second controller segment 310b can be configured to be held in a user's right and left hands, respectively. Accordingly, in some embodiments, the first controller segment 310a and the second controller segment 310b can be symmetrically arranged relative to each other. In some embodiments, the first controller segment 310a and the second controller segment 310b can be asymmetrically arranged. As can be appreciated, the controller segments 310a, 310b can each be in an linear or rotated configuration. Further, the first controller segment 310a and the second controller segment 310b can have different components, arrangements, and/or features.

Each controller segment 310a, 310b, can be used in an independent configuration wherein the user can control the external device at least partially through the independent motion of each of the user's hands and/or arms. As can be appreciated, each controller segment 310a, 310b can be used independently while in either a linear or rotated configuration. For example, in a linear configuration, the controller segments 310a, 310b can have a form factor that allows the user to grasp the handle portion 340a, 340b between the user's fingers and palm while the segment body 312a, 312b extends upwards or otherwise linearly away from the handle portion 340a, 340b leaving the user's thumb to interact with the interface portion 316a, 316b and other controls described herein. Further, in an rotated configuration, the controller segments 310a, 310b can have a form factor that allows the user to grasp the handle portion 340a, 340b between the user's fingers and palm while the segment body 312a, 312b extends away from the handle portion 340a, 340b, leaving the user's thumb to interact with the interface portion 316a, 316b and other control described herein.

Alternatively, the controller segments 310a, 310b can be joined together and used in tandem in a joined or combined configuration, wherein the user can control the external device through inputs provided by the user's digits with both of the user's hands at generally common position. For example, during operation, the controller segments 310a, 310b can be joined together as a unified controller device 300. For example, the segment body 312a of the first controller segment 310a can be joined together with the segment body 312b of the second controller segment 310b, allowing the user to grasp the handle portion 340a of the right controller segment 310a in the right hand and the handle portion 340b of the left controller segment 310b in the left hand.

The controller segments 310a, 310b can be joined together with each controller segment 310a, 310b in linear or rotated configuration. With reference to FIG. 5, in a linear configuration, the controller device 300 can have a form factor or shape configured to be held between both of the user's hands in a linear, or spaced apart arrangement. For example, the handle portions 340a, 340b can extend away from the joined bodies 312a, 312b linearly such that the user's hands are longitudinally spaced apart when grasping the handle portions 340a, 340b.

With reference to FIG. 6, in a rotated configuration, the controller device 300 can have a form factor or shape configured to be held between both of the user's hands at an angle relative to each other. For example, the handle portions 340a, 340b can extend away from the joined bodies 312a, 312b at an obtuse angle to allow the user's hands and/or arms to be positioned in a comfortable manner when the controller segments 310a, 310b are joined together. As can be appreciated, one of the controller segments 310a, 310b can be in a linear configuration while another controller segment 310a, 310b is in a rotated configuration.

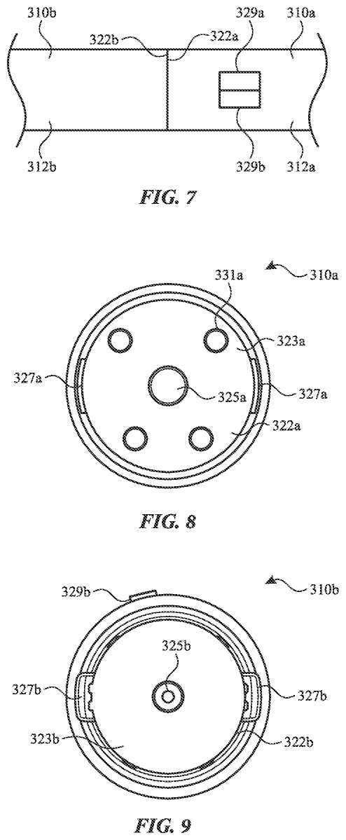

With reference to FIGS. 7-9, in the depicted example, the first controller segment 310a and the second controller segment 310b are releasably attached to each other to allow the controller device 300 to be used in an independent or joined configuration. In some embodiments, the segment body 312a of the first controller segment 310a can releasably engage with a segment body 312a of the second controller segment 310b.

During operation, an engagement mechanism 323a of the first controller segment 310a can engage with an engagement mechanism 323b of the second controller segment 310b to releasably attach the first controller segment 310a to the second controller segment 310b.

In some embodiments, the engagement mechanisms 323a, 323b can include one or more features described herein (such as engagement window 329a, engagement pin 329b, engagement slots 327a, engagement features 327b, electrical contacts 325a, 325b, 331a, etc.) to allow for releasable attachment or connection between the controller segments 310a, 310b.

With reference to FIG. 7, the engagement mechanism 323a can include an engagement window 329a and the engagement mechanism 323b can include an engagement pin 329b, wherein the engagement window 329a and the engagement pin 329b can interlock to releasably attach the controller segments 310a, 310b. In some embodiments, upon attachment, an extension portion of the segment body 312b can extend into a lip or hollow portion of the segment body 312a.

The engagement window 329a can be defined on the lip or hollow portion of the segment body 312a adjacent to the engagement face 322a. The engagement window 329a can extend radially through the thickness of the segment body 312a at the lip or hollow portion, defining a rectangular slot through the segment body 312a. The engagement pin 329b can be formed as a protrusion on the extension portion of the segment body 312b.

Upon insertion of the extension of the segment body 312b into the lip of the segment body 312a, the engagement pin 329b can extend through the engagement window 329a. retaining the first controller segment 310a with the second controller segment 310b. In some embodiments, the engagement pin 329b can be radially extended or retracted by rotating the handle portion 340b of the second controller segment 310b. For example, the engagement pin 329b can be extended radially outward away from the segment body 312b to allow for the engagement pin 329b to interlock with the engagement window 329a, by moving the handle portion 340b toward a rotated position. Further, the engagement pin 329b can be radially retracted toward the segment body 312b to allow for the engagement pin 329b to release from the engagement window 329a, by moving the handle portion 340b toward a linear position. Optionally, the engagement pin 329b can be urged by a biasing member or a deformable member that allows the engagement pin 329b to selectively engage with the engagement window 329a and release after a predetermined force is applied. In other embodiments, the engagement pin 329b can be inserted and removed from the engagement window 329a through a keyed slot.

In the depicted example, the engagement window 329a is disposed around or otherwise adjacent to an engagement face 322a of the segment body 312a and the engagement pin 329b is disposed around or otherwise adjacent to an engagement face 322b of the segment body 312b, providing contact between the engagement faces 322a, 322b during engagement.

In some embodiments, the engagement faces 322a, 322b are planar surfaces that allow contact and/or engagement between the first controller segment 310a and the second controller segment 310b. Optionally, when the first controller segment 310a and the second controller segment 310b are coupled or otherwise engaged to each other, the engagement faces 322a, 322b of the bodies 312a, 312b can be in direct contact with each other with no intermediate connection portions or pieces. In some embodiments, the first controller segment 310a and the second controller segment 310b can be connected together with an intermediate connection portion, spacing apart the engagement faces 322a, 322b.

With reference to FIGS. 8 and 9, the engagement mechanism 323a can include engagement slots 327a and the engagement mechanism 323b can include engagement features 327b, wherein the engagement slots 327a and the engagement features 327b can interlock to releasably attach the controller segments 310a, 310b.

The engagement slots 327a can be defined on the lip or hollow portion of the segment body 312a adjacent to the engagement face 322a. The segment body 312a can include multiple engagement slots 327a circumferentially spaced apart. The engagement slots 327a can extend partially through the thickness of the segment body 312a at the lip or hollow portion, defining keyed slots through the segment body 312a. The engagement features 327b can be keyed members formed as protrusions on the extension portion of the segment body 312b.

Upon insertion of the extension of the segment body 312b into the lip of the segment body 312a, the engagement features 327b can slide into the engagement slots 327a. After insertion, the engagement features 327b can be rotated within the keyed portion of engagement slots 327a to retain the engagement features 327b within the engagement slots 327a and therefore prevent the segment body 312b from being axially removed from the segment body 312a. Further, the engagement features 327b can be rotated in an opposite direction to remove the engagement features 327b from the keyed portion of the engagement slots 327a. In some embodiments, the engagement features 327b can be rotated by rotating the segment body 312b. Optionally, the keyed members or engagement features 327b can be actuated or rotated independent of the segment body 312b by rotating the handle portion 340b relative to the segment body 312b. Alternatively, the engagement slots 327a can be rotated to retain the engagement features 327b within the engagement slots 327a. Similarly, the engagement slots 327a can be actuated or rotated by rotating the segment body 312a or by rotating the handle portion 340a relative to the segment body 312a.

In the depicted example, the engagement slots 327a are disposed around or otherwise adjacent to an engagement face 322a of the segment body 312a and the engagement features 327b are disposed around or otherwise adjacent to an engagement face 322b of the segment body 312b, providing contact between the engagement faces 322a, 322b during engagement.

In some embodiments, the engagement mechanisms 323a, 323b can provide electrical connections between the first controller segment 310a and the second controller segment 310b when engaged. In the depicted example, the engagement mechanism 323a, 323b can include electrical contacts 325a, 325b.

As illustrated, the electrical contacts 325a, 325b can be disposed on the engagement faces 322a, 322b of the controller segments 310a, 310b. In some embodiments, additional electrical contacts 331a can be utilized. Accordingly, when the controller segments 310a, 310b are engaged, the electrical contacts 325a, 325b can be in contact with each other to transfer power and/or signals therethrough. The electrical contacts 325a, 325b can be utilize “pogo pins,” spring-fingers, or other biasing members to urge a portion of the electrical contact 325a, 325b toward the mating electrical contact to maintain a reliable connection. Electrical contacts 331a can utilize a similar construction to provide additional electrical connections. Advantageously, by providing electrical connections between the controller segments 310a, 310b, the controller device 300 can share signals, sensors, outputs, power sources, etc. between the controller segments 310a, 310b.

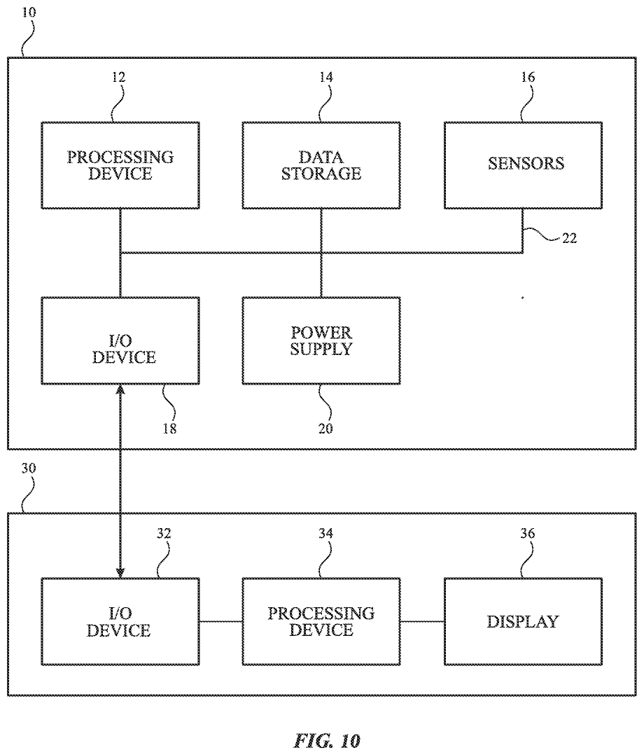

Referring now to FIG. 10, components of a controller device can be operably connected to each other and/or an external device to provide desired functions. FIG. 10 shows a simplified block diagram of an illustrative controller device 10 and an external device 30 in accordance with one embodiment of the invention. It will be appreciated that components described herein can be provided on either or both segments of any of the controller devices described herein.

The controller device 10 can include one or more processing devices 12, one or more data storage devices 14, input/output (I/O) device 18, a power source 20, and one or more sensors 16. The one or more processing devices 12 can control some or all of the operations of the controller device 10. The processing device 12 can communicate, either directly or indirectly, with substantially all of the components of the controller device 10. For example, one or more system buses or signal lines 22 or other communication mechanisms can provide communication between the processing device 12, the data storage device 14, the I/O device 18, the power source 20, and/or the sensor 16. The processing device 12 can be implemented as any electronic device capable of processing, receiving, or transmitting data or instructions. For example, the one or more processing devices 12 can be a microprocessor, a central processing unit (CPU), an application-specific integrated circuit (ASIC), a digital signal processor (DSP), or combinations of multiple such devices. As described herein, the term “processing device” is meant to encompass a single processor or processing unit, multiple processors, multiple processing units, or other suitably configured computing element or elements.

The data storage device 14 can store electronic data that can be used by the controller device 10. For example, a data storage device can store electrical data or content such as, for example, audio files, settings and user preferences, and timing signals. The data storage device 14 can be configured as any type of memory. By way of example only, the memory can be implemented as random access memory, read-only memory, Flash memory, removable memory, or other types of storage elements, in any combination.

The input/output device 18 can receive data from a user or one or more other electronic devices. In other embodiments, the I/O device 18 can include a display, a touch sensing input surface such as a trackpad, one or more buttons, one or more microphones or speakers, and/or a keyboard. For example, the one or more sensors 16 can include the interface portion 116a or the interface portion 116b. The one or more sensors 16 can further the trigger button 120a.

The input/output device 18 or another component of the controller device 10 can provide feedback to a user operating the controller device. For example, the controller device 10 can include a haptic feedback component that provides haptic feedback with tactile sensations to the user. The haptic feedback component can be implemented as any suitable device configured to provide force feedback, vibratory feedback, tactile sensations, and the like. For example, in one embodiment, the haptic feedback component may be implemented as a linear actuator configured to provide a punctuated haptic feedback, such as a tap or a knock. Haptic feedback can be provided during operation of the controller device 10, such as while being held by a user. For example, haptic feedback can be provided in response to a user input. Additionally or alternatively, haptic feedback can be provided during attachment and/or detachment of the segments of the controller device 10. For example, the haptic feedback can be provided upon joining the segments to confirm to the user that attachment has been achieved. By further example, the haptic feedback can be provided upon separation of the segments to confirm to the user that detachment has been achieved.

In some embodiments, the controller device can include a thermal feedback component that can provide thermal feedback with temperature sensations to the user. The thermal feedback component can be implemented as any suitable device configured to provide thermal feedback. For example, in one embodiment, the thermal feedback component may be implemented as a resistive heating element coupled to the body of the controller device.

The power source 20 can be implemented with any device capable of providing energy to the controller device 10. For example, the power source 20 can be one or more batteries or rechargeable batteries, or a connection cable that connects the controller device to another power source such as a wall outlet. As can be appreciated, the power source 20 can be disposed within either or both of multiple segments of any of the controller devices described herein.

Additionally or alternatively, the one or more sensors 16 can include any suitable type of sensor or sensors, such as a motion sensor, a proximity sensor, an orientation sensor (e.g., gyroscope), and/or an accelerometer.

The sensors 16 can include one or more sensors for tracking position, movement, orientation, and/or one or more other characteristics of the controller device 10 during user. For example, the controller device 10 can include a camera for capturing a view of an environment external to the controller device 10. The camera can include an optical sensor, such as a photodiode or a photodiode array. Additionally or alternatively, the camera can include one or more of various types of optical sensors that are arranged in various configurations for detecting user inputs described herein. The camera may be configured to capture an image of a scene or subject located within a field of view of the camera. The image may be stored in a digital file in accordance with any one of a number of digital formats. In some embodiments, the controller device 10 includes a camera, which includes an image sensor formed from a charge-coupled device (CCD) and/or a complementary metal-oxide-semiconductor (CMOS) device, a photovoltaic cell, a photo resistive component, a laser scanner, and the like. It will be recognized that a camera can include other motion sensing devices.

The sensors 16 can include an inertial measurement unit (“IMU”) that provides information regarding a characteristic of the controller device 10, such as inertial angles thereof. For example, the IMU can include a six-degrees of freedom IMU that calculates the controller device's position, velocity, and/or acceleration based on six degrees of freedom (x, y, z, θₓ, θ_{y}, and θ_{z}). The IMU can include one or more of an accelerometer, a gyroscope, and/or a magnetometer. Additionally or alternatively, the controller device 10 can detect motion characteristics of the controller device 10 with one or more other motion sensors, such as an accelerometer, a gyroscope, a global positioning sensor, a tilt sensor, and so on for detecting movement and acceleration of the controller device 10. The IMU can provide data to the processing device 12 for processing.

Additionally or alternatively, the sensors 16 can include one or more environment sensors that are directed to an external environment. Such environment sensors can include any sensor that detects one or more conditions in an environment of the controller device 10. For example, an environment sensor can include an imaging device, a thermal sensor, a proximity sensor, a motion sensor, a humidity sensor, a chemical sensor, a light sensor, magnetometer, IR sensor, and/or a UV sensor. An environment sensor can be configured to sense substantially any type of characteristic such as, but not limited to, images, pressure, light, touch, force, temperature, position, motion, magnetic fields, and so on. For example, the environment sensor may be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. The sensor can be used to sense ambient conditions in a neighboring environment.

The sensors 16 can include one or more user sensors for tracking features of the user wearing the controller device 10. For example, a user sensor can perform facial feature detection, facial movement detection, facial recognition, eye tracking, user mood detection, user emotion detection, voice detection, etc. By further example, the user sensor can be a bio-sensor for tracking biometric characteristics, such as health and activity metrics. The user sensor can include a bio-sensor that is configured to measure biometrics such as electrocardiographic (ECG) characteristics, galvanic skin resistance, and other electrical properties of the user's body. Additionally or alternatively, a bio-sensor can be configured to measure body temperature, exposure to UV radiation, and other health-related information.

The controller device 10 can communicate with an external device 30 via the I/O device 18 and an I/O device 32 of the external device 30. For example, the input/output device 18 can facilitate transmission of data to the external device 30. By further example, an I/O device 18 can transmit electronic signals via a wireless or wired connection. Examples of wireless and wired connections include, but are not limited to, WiFi, Bluetooth, infrared, and Ethernet. Examples of external devices include computers, tablet computing devices, video streaming media player devices, and/or gaming devices. Such devices can include or be connected to a display 36 that outputs visual information to the user. Other outputs are contemplated, including audio. Such operations of the external device 30 can be managed by a processing device 34 thereof.

The controller devices of the present disclosure can facilitate the user input operations to be communicated to an external device. Such external devices can include televisions, DVD players, stereos, game consoles, networked devices, computers, tablet computing devices, video streaming media player devices, head-mountable devices, virtual reality systems, augmented reality systems, and mixed reality systems. It will be understood that a given external device can perform one or more of the functions associated with the external devices described herein. The will be further understood that the functions associated with the external devices described herein can be performed by one or more external devices.

As discussed herein, the user inputs can be transmitted to the corresponding external device to manage one or more operations thereof. Accordingly, the input provided by the user can be interpreted as commands that are to be executed as actions performed by the external device according to the programming thereof. Such programming can be output to a user in a manner that educates the user on the relationship between the user inputs received by the controller device and the actions to be performed by the external device.

In some embodiments, the external device is a head-mountable device that is worn on a head of the user and provides visual, audio, and/or tactile output to the user. The head-mountable device can further receive inputs from the user. At least some of the inputs can be provided via the controller device 100 and communicated to the head-mountable device. The head-mountable device can thereby be operated to allow a user to provide inputs in a manner that allows the user to interact with a visual output displayed by the head-mountable device. Such visual output can include information and features overlaid with a view of a physical environment. A physical environment refers to a physical world that people can sense and/or interact with without aid of electronic systems. In contrast, a computer-generated reality environment refers to a wholly or partially simulated environment that people sense and/or interact with via an electronic system. Examples of computer-generated reality include virtual reality and mixed reality. A virtual reality environment refers to a simulated environment that is designed to be based entirely on computer-generated sensory inputs for one or more senses. In contrast to a virtual reality environment, which is designed to be based entirely on computer-generated sensory inputs, a mixed reality environment refers to a simulated environment that is designed to incorporate sensory inputs from the physical environment, or a representation thereof, in addition to including computer-generated sensory inputs (e.g., virtual objects). Examples of mixed realities include augmented reality and augmented virtuality. An augmented reality environment refers to a simulated environment in which one or more virtual objects are superimposed over a physical environment, or a representation thereof. An augmented virtuality environment refers to a simulated environment in which a virtual or computer generated environment incorporates one or more sensory inputs from the physical environment.

There are many different types of electronic systems that enable a person to sense and/or interact with various computer-generated reality environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Accordingly, embodiments of the present disclosure provide controller devices provide a user with multiple modes of operation. For example, the user can hold and operate the controller device in a first configuration for control of a first device and/or first mode of a device (e.g. augmented reality or virtual reality programming), and the user can hold and operate controller segments of the controller device in a second configuration for control of a second device and/or second mode of a device (e.g. navigating an interface). The controller segments can be selectively engaged and disengaged to facilitate user operation in the different modes.

Various examples of aspects of the disclosure are described below as clauses for convenience. These are provided as examples, and do not limit the subject technology.

Clause A: a controller device comprising: a first controller segment comprising: a first segment body comprising: a first handle portion; and a first movable portion movably coupled to the first handle portion via a first joint; a first interface portion defined on the first handle portion, wherein the first interface portion is configured to receive input from a user; and a first engagement mechanism coupled to the first segment body; and a second controller segment comprising: a second segment body comprising: a second handle portion; and a second movable portion movably coupled to the second handle portion via a second joint; a second interface portion defined on the second handle portion, wherein the second interface portion is configured to receive input from the user;; and a second engagement mechanism coupled to the second segment body, wherein the first engagement mechanism is configured to engage with the second engagement mechanism to releasably couple the first controller segment and the second controller segment.

Clause B: a controller segment comprising: a segment body comprising: a handle portion; and a bridge portion rotatably coupled to the handle portion about a pivot; an interface portion defined on the handle portion of the segment body, wherein the interface portion is configured to receive input from a user; and an engagement mechanism disposed on the bridge portion of the segment body, the engagement mechanism configured to releasably engage the controller segment with a mating controller segment.

Clause C: a controller segment comprising: a segment body; a handle portion extending from the segment body, wherein the handle portion is rotatable relative to the segment body; an interface portion defined on the handle portion, wherein the interface portion is configured to receive input from a user; and an engagement mechanism coupled to the segment body, wherein rotation of the handle portion relative to the segment body actuates the engagement mechanism to releasably engage the controller segment with a mating controller segment.

One or more of the above clauses can include one or more of the features described below. It is noted that any of the following clauses may be combined in any combination with each other, and placed into a respective independent clause, e.g., clause A, B, or C.

Clause 1: the first movable portion of the first controller segment is movable relative to the first handle portion between a first position and a second position.

Clause 2: the first engagement mechanism is configured to be actuated by movement of the first movable portion.

Clause 3: the first engagement mechanism comprises a magnetic engagement mechanism.

Clause 4: the first engagement mechanism comprises an electrical connection configured to transfer signals to the second controller segment.

Clause 5: the first segment body comprises an ellipsoidal shape.

Clause 6: the handle portion defines a cavity and the bridge portion is rotatable to be positioned within the cavity.

Clause 7: the engagement mechanism is obscured by the handle portion when the bridge portion is positioned within the cavity.

Clause 8: rotation of the bridge portion extends the engagement mechanism relative to the bridge portion.

Clause 9: further comprising a biasing member coupled to the handle portion and the bridge portion, the biasing member configured to urge the bridge portion to rotate relative to the handle portion.

Clause 10: further comprising a locking mechanism releasably retaining the handle portion and the bridge portion at a desired angle.

Clause 11: the bridge portion is laterally extendable relative to the handle portion.

Clause 12: the bridge portion is configured to releasably engage with a mating bridge portion of the mating controller segment.

Clause 13: the engagement mechanism comprising at least one electrical contact to provide an electrical connection with the mating controller segment.

Clause 14: the at least one electrical contact comprises a biasing member to urge a portion of the electrical contact away from the segment body.

Clause 15: the engagement mechanism comprising a keyed member extending from the segment body, wherein the keyed member is configured to engage with the mating controller segment.

Clause 16: rotation of the handle portion relative to the segment body actuates the keyed member relative to the segment body.

Clause 17: the segment body comprises a face disposed opposite to the engagement mechanism, the face defining a diagonal plane, wherein the handle portion rotatable relative to the segment body about the diagonal plane.

As described above, information can be gathered from various sources in the methods described herein. The gathered information may include personal information data that uniquely identifies or can be used to contact or locate a specific person. The present disclosure recognizes that the use of such personal information or other data can be used to the benefit of users. The collection, analysis, disclosure, transfer, storage, or other use of such personal information and/or data can comply with well-established privacy policies and/or privacy practices. Users can selectively block the use of, or access to, personal information data. The risks of unintentional or unauthorized access or use can be managed and/or minimized.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A controller device, comprising:
a first controller segment comprising:
a first segment body comprising:
a first handle portion; and
a first movable portion movably coupled to the first handle portion via a first joint;
a first interface portion defined on the first handle portion, wherein the first interface portion is configured to receive input from a user; and
a first engagement mechanism coupled to the first segment body; and
a second controller segment comprising:
a second segment body comprising:
a second handle portion; and
a second movable portion movably coupled to the second handle portion via a second joint;
a second interface portion defined on the second handle portion, wherein the second interface portion is configured to receive input from the user; and
a second engagement mechanism coupled to the second segment body, wherein the first engagement mechanism is configured to engage with the second engagement mechanism to releasably couple the first controller segment and the second controller segment.

2. The controller device of claim 1, wherein the first movable portion of the first controller segment is movable relative to the first handle portion between a first position and a second position.

3. The controller device of claim 1, wherein the first engagement mechanism is configured to be actuated by movement of the first movable portion.

4. The controller device of claim 1, wherein the first engagement mechanism comprises a magnetic engagement mechanism.

5. The controller device of claim 1, wherein the first engagement mechanism comprises an electrical connection configured to transfer signals to the second controller segment.

6. The controller device of claim 1, wherein the first segment body comprises an ellipsoidal shape.

7. A controller segment, comprising:
a segment body comprising:
a handle portion; and
a bridge portion rotatably coupled to the handle portion about a pivot;
an interface portion defined on the handle portion of the segment body, wherein the interface portion is configured to receive input from a user; and
an engagement mechanism disposed on the bridge portion of the segment body, the engagement mechanism configured to releasably engage the controller segment with a mating controller segment.

8. The controller segment of claim 7, wherein the handle portion defines a cavity and the bridge portion is rotatable to be positioned within the cavity.

9. The controller segment of claim 8, wherein the engagement mechanism is obscured by the handle portion when the bridge portion is positioned within the cavity.

10. The controller segment of claim 7, wherein rotation of the bridge portion extends the engagement mechanism relative to the bridge portion.

11. The controller segment of claim 7, further comprising a biasing member coupled to the handle portion and the bridge portion, the biasing member configured to urge the bridge portion to rotate relative to the handle portion.

12. The controller segment of claim 7, further comprising a locking mechanism releasably retaining the handle portion and the bridge portion at a desired angle.

13. The controller segment of claim 7, wherein the bridge portion is laterally extendable relative to the handle portion.

14. The controller segment of claim 7, wherein the bridge portion is configured to releasably engage with a mating bridge portion of the mating controller segment.

15. A controller segment, comprising:
a segment body;
a handle portion extending from the segment body, wherein the handle portion is rotatable relative to the segment body;
an interface portion defined on the handle portion, wherein the interface portion is configured to receive input from a user; and
an engagement mechanism coupled to the segment body, wherein rotation of the handle portion relative to the segment body actuates the engagement mechanism to releasably engage the controller segment with a mating controller segment.

16. The controller segment of claim 15, the engagement mechanism comprising at least one electrical contact to provide an electrical connection with the mating controller segment.

17. The controller segment of claim 16, wherein the at least one electrical contact comprises a biasing member to urge a portion of the electrical contact away from the segment body.

18. The controller segment of claim 15, the engagement mechanism comprising a keyed member extending from the segment body, wherein the keyed member is configured to engage with the mating controller segment.

19. The controller segment of claim 18, wherein rotation of the handle portion relative to the segment body actuates the keyed member relative to the segment body.

20. The controller segment of claim 15, wherein the segment body comprises a face disposed opposite to the engagement mechanism, the face defining a diagonal plane, wherein the handle portion rotatable relative to the segment body about the diagonal plane.
